(19) United States
(12) Patent Application Publication
(10) Pub. No.: US 2021/0335357 A1
(43) Pub. Date: Oct. 28, 2021

(54) METHOD FOR CONTROLLING INTELLIGENT SPEECH APPARATUS, ELECTRONIC DEVICE AND STORAGE MEDIUM

(71) Applicant: BAIDU ONLINE NETWORK TECHNOLOGY (BEIJING) CO., LTD., Beijing (CN)

(72) Inventors: Wenyu WANG, Beijing (CN); Liangcheng WU, Beijing (CN); Lei ZHONG, Beijing (CN)

(21) Appl. No.: 17/107,397

(22) Filed: Nov. 30, 2020

(30) Foreign Application Priority Data
Apr. 28, 2020 (CN) 202010350353.X

(51) Int. Cl. G10L 15/22; H04L 29/08; G10L 15/18; G06F 3/16

(52) U.S. Cl. CPC G10L 15/22; H04L 67/26; G06F 3/14; G06F 3/165; G10L 15/1822

(57) ABSTRACT

The disclosure provides a method for controlling an intelligent speech apparatus, an electronic device and a storage medium. The method includes: receiving a play command comprising a target file identifier; determining a file permission of a target file corresponding to the target file identifier; playing a preset push information, when the file permission does not match a current user permission of a user of the intelligent speech apparatus; and playing the target file when receiving speech data associated with the push information within a preset time period.

### CROSS REFERENCE TO RELATED APPLICATION

This application is based on and claims priority to Chinese Patent Application No. 202010350353.X, filed on Apr. 28, 2020, the entire content of which is hereby incorporated by reference.

### TECHNICAL FIELD

The disclosure relates to a field of computer technologies, especially a field of speech technologies, and more particular to, a method for controlling an intelligent speech apparatus, an electronic device and a storage medium.

### BACKGROUND

Currently, with rapid development of artificial intelligence and continuous improvement of people's living standards, intelligent speech apparatuses have become a household necessity. Users perform speech interaction with the intelligent speech apparatuses, or play music and news through the intelligent speech apparatuses.

### SUMMARY

In a first aspect, embodiments of the disclosure provide a method for controlling an intelligent speech apparatus. The method includes: receiving a play command comprising a target file identifier; determining a file permission of a target file corresponding to the target file identifier; controlling the intelligent speech apparatus to play a preset push information, when the file permission does not match a current user permission of a user of the intelligent speech apparatus; and playing the target file when receiving speech data associated with the push information within a preset time period.

In a second aspect, embodiments of the disclosure provide an electronic device. The electronic device includes: at least one processor, and a memory communicatively connected to the at least one processor. The memory stores instructions executable by the at least one processor, and the processor is configured to:

receive a play command comprising a target file identifier;

determine a file permission of a target file corresponding to the target file identifier;

perform a first instruction to play a preset push information, when the file permission does not match a current user permission of a user of the intelligent speech apparatus; and

perform a second instruction to play the target file when receiving speech data associated with the push information within a preset time period.

In a third aspect, embodiments of the disclosure provide a non-transitory computer-readable storage medium storing computer instructions. When the instructions are executed, the computer is caused to implement a method for controlling the intelligent speech apparatus. The method includes:

receiving a play command comprising a target file identifier;

determining a file permission of a target file corresponding to the target file identifier;

playing a preset push information, when the file permission does not match a current user permission of a user of the intelligent speech apparatus; and

playing the target file when receiving speech data associated with the push information within a preset time period

### BRIEF DESCRIPTION OF THE DRAWINGS

The drawings are used to better understand the solution and do not constitute a limitation to the disclosure, in which:

FIG. 1 is a flowchart of a method for controlling an intelligent speech apparatus according to an embodiment of the disclosure.

FIG. 2 is a flowchart of another method for controlling an intelligent speech apparatus according to an embodiment of the disclosure.

FIG. 3 is a flowchart of yet another method for controlling an intelligent speech apparatus according to an embodiment of the disclosure.

FIG. 4 is a schematic diagram of a display component according to an embodiment of the disclosure.

FIG. 5 is a schematic diagram of an apparatus for controlling an intelligent speech apparatus according to an embodiment of the disclosure.

FIG. 6 is a schematic diagram of another apparatus for controlling an intelligent speech apparatus according to an embodiment of the disclosure.

FIG. 7 is a block diagram of an electronic device used to implement the method for controlling an intelligent speech apparatus according to an embodiment of the disclosure.

### DETAILED DESCRIPTION

The following describes the exemplary embodiments of the present disclosure with reference to the accompanying drawings, which includes various details of the embodiments of the present disclosure to facilitate understanding, which shall be considered merely exemplary. Therefore, those of ordinary skill in the art should recognize that various changes and modifications can be made to the embodiments described herein without departing from the scope and spirit of the present disclosure. For clarity and conciseness, descriptions of well-known functions and structures are omitted in the following description.

A method and an apparatus for controlling an intelligent speech apparatus, an electronic device and a storage medium are described below with reference to the accompanying drawings.

The embodiment of the disclosure provides a method for controlling an intelligent speech apparatus to solve the problem of single speech interaction mode of the intelligent speech apparatus in the related arts.

The method for controlling the intelligent speech apparatus according to the embodiment of the disclosure provides the push information to the user when using the non-authorized files, which not only enriches speech interaction modes, but also deepens the user's awareness of the push information and improves information pushing effect.

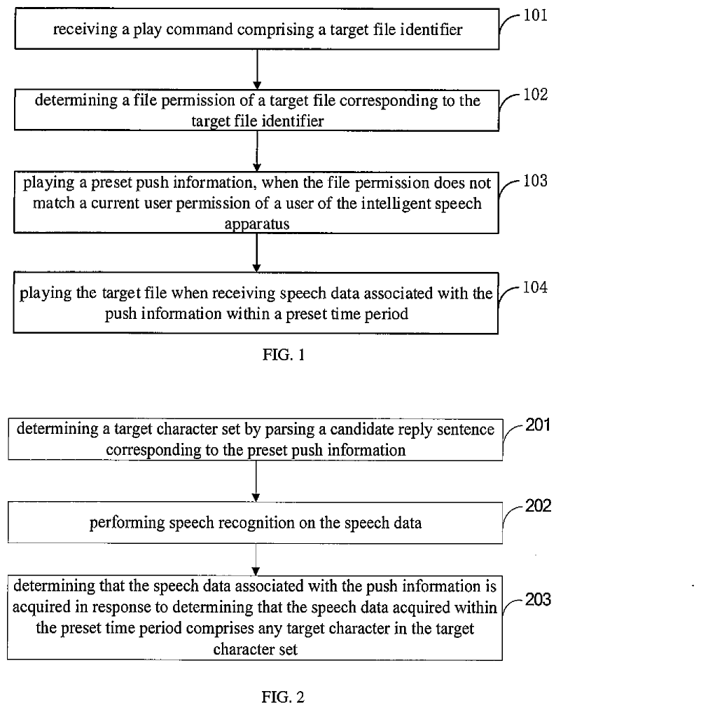

FIG. 1 is a flowchart of a method for controlling an intelligent speech apparatus according to an embodiment of the disclosure.

The method for controlling the intelligent speech apparatus according to the embodiment of the disclosure is applicable to the intelligent speech apparatus capable of performing speech interaction, such as smart speakers, computers and other electronic devices, so as to provide the push information to the user when using the non-authorized files.

As illustrated in FIG. 1, the method for controlling the intelligent speech apparatus includes the following steps.

At block 101, a play command including a target file identifier is obtained.

In practical applications, the user performs speech interaction with the intelligent speech apparatus such as a smart speaker, and controls the intelligent speech apparatus to play files such as songs and stories through speech.

After the intelligent speech apparatus is awakened, the user input the play command through speech, for example, “playing song A”. At this time, the intelligent speech apparatus collects the speech input by the user and obtains the play command. The play command includes the target file identifier, which may be a name of the target file, or a type of the target file.

For example, when a speech of “playing song A” is input by the user, the target file identifier is A. When a speech of “playing a children's song” is input by the user, the target file identifier is the type of the song, i.e., “children's song”. When a speech of “play a song of singer a” is input by the user, the target file identifier is the name of the singer, i.e., a.

Alternatively, the play command is received when the intelligent speech apparatus is automatically triggered. In detail, when playing of a previous file is completed, playing a certain file is automatically triggered, and the play command is received at this time. The play command includes the file identifier of the file. For example, in a playlist of a certain audio novel, when playing of a chapter is completed, the next chapter is automatically played, and the play command of the next chapter is received.

At block 102, a file permission of a target file corresponding to the target file identifier is determined.

In this embodiment, correspondence between the file identifiers and the file permissions of the files played by the, intelligent speech apparatus is preset to obtain a file permission database. The file permissions include free files, VIP files and super VIP files, or the file permissions include free files and member files, or the file permissions include ordinary files and paid files. Specific file permissions are divided according to requirements, which is not limited in the embodiment.

After obtaining the play command, the file permission of the target file corresponding to the target file identifier is determined by querying the file permission database according to the target file identifier.

For example, when the speech of “play a song by singer a” is input by the user, it is determined that the file permission of the song of singer a is free.

At block 103, the intelligent speech apparatus is controlled to play a preset push information, when the file permission does not match a current user permission of a user of the intelligent speech apparatus.

When using the intelligent speech apparatus, different users have different permissions. In this embodiment, the current user permission of the user of the intelligent speech apparatus is represented by user levels. The higher the user level, the higher the user permission. For example, the user levels include: ordinary users, VIP users and super VIP users. Different user permissions correspond to different rights and benefits.

Since the user permission may change depending on the interaction between the user and the intelligent speech apparatus, the current user permission of the user is obtained every time the play command is received.

In this embodiment, the file permissions of files used based on different user permissions may be predetermined. After the file permission of the target file is determined, whether the file permission of the target file match the current user permission of the user of the intelligent speech apparatus is determined. In detail, it is determined whether the current user permission is allowed to access the file with the file permission.

When the file permission does not match the current user permission of the user of the intelligent speech apparatus, the user of the intelligent speech apparatus could not use the target file, that is, the intelligent speech apparatus could not directly play the target file. At this time, the intelligent speech apparatus is controlled to play the preset push information.

The push information may include question and answer sentences. The push information may be advertisements placed by advertisers, or other content, which could be preset according to requirements.

For example, a speech of “playing song B” is input to the intelligent speech apparatus by the user. When the file permission of song B is available only to members, in response to the current user permission of the user being an ordinary user, the ordinary user could not listen to song B, and the intelligent speech apparatus plays the preset push information “This song is members only. One day of membership permissions could be enjoyed by completing interactive questions and answers. What day is the consumer rights protection day, Number one: March 15, Number two: April 15”.

At block 104, the target file is played when receiving speech data associated with the push information within a preset time period.

In detail, the intelligent speech apparatus collects speech data after playing the push information. In response to the speech data being collected within a preset time period, the speech data is recognized and a correlation between the content of the speech data and the push information is calculated to determine whether the speech data is associated with the push information. For example, the push information is a question sentence, and the speech data may be a sentence related to the answer.

In response to the correlation between the collected speech data and the push information being greater than a preset threshold, it is determined that the speech data is associated with the push information, then the target file is played. In response to the collected speech data being not associated with the push information, or irrelevant to the push information, the intelligent speech apparatus does not play the target file.

That is, after the intelligent speech apparatus has played the push information, in response to inputting the speech data associated with the push information by the user within the preset time period, the intelligent speech apparatus may play the target file, which not only enriches interaction between the user and the intelligent device, but also enables the user to use the files without the permission, thus user experience is improved.

For example, the push information is “in which city will singer a hold a concert in April this year? Number 1: M city, Number 2: N city”. In response to speaking a correct answer by the user within the preset time period such as 30 seconds, the target file is played.

In practical applications, the user permission is increased in response to the speech data associated with the push information being acquired within the preset time period, according to a pre-set rule. Therefore, the user permission is updated after the corresponding interaction is completed.

For example, the push information reads “This song is members only. One day of membership permissions could be enjoyed by completing interactive questions and answers. What day is the consumer rights protection day, Number one: March 15, Number two: April 15”. In response to answering the question by the user within 20 seconds, the user could enjoy the membership within the following 24 hours. Namely, the user permission is updated from the ordinary user to the member user for a duration of 24 hours from the completion of the interaction.

In the embodiment of the disclosure, the file permission in the play command are matched with the current user permission of the user of the intelligent speech apparatus. When the file permission does not match the current user permission, the intelligent speech apparatus is controlled to play the preset push information. Therefore, the method provides the push information to the user when using the files without permission, which not only enriches speech interaction modes, but also deepens the user's awareness of the push information and improves information pushing effect.

In order to improve the interaction effect between the user and the intelligent speech apparatus, in an embodiment of the disclosure, when the intelligent speech apparatus receives any answer option of the push information, the target file is played. FIG. 2 is a flowchart of another method for controlling an intelligent speech apparatus according to an embodiment of the disclosure.

As illustrated in FIG. 2, receiving the speech data associated with the push information within the preset time period includes the following blocks.

At block 201, a target character set is determined by parsing a candidate reply sentence corresponding to the preset push information.

In this embodiment, each preset push information has the corresponding candidate reply sentence. The candidate reply sentence may include each answer option corresponding to the question in the push information.

In detail, the push information includes the question and the candidate reply sentences. The candidate reply sentences are parsed to obtain the target character set. The target character set may include each answer option and the corresponding answer.

For example, the push information reads “What day is the consumer rights protection day? Number one: March 15, Number two: April 15”. “Number one: March 15” and “Number two: April 15” are the candidate reply sentences corresponding to the push information. The candidate reply sentences are parsed, and the target character set {Number one: March 15; Number two: April 15} is obtained, and the character set includes two characters.

At block 202, speech recognition is performed on the speech data.

In this embodiment, the intelligent speech apparatus performs speech collection after playing the preset push information. In response to the speech data being collected within the preset time period, speech recognition is performed on the acquired speech data to determine contents contained in the speech data.

At block 203, it is determined that the speech data associated with the push information is acquired in response to determining that the speech data acquired within the preset time period comprises any target character in the target character set.

After the speech recognition of the acquired speech data is completed, the recognition result of the speech data is matched with the characters in the target character set. In response to the characters included in the speech data being the characters in the target character set, that is, the speech data including any target character in the target character set, it is determined that the speech data associated with the push information is acquired.

For example, the push information reads “in which city will singer a hold a concert in April this year? Number 1: M city, Number 2: N city”. In response to inputting any one of “Number 1”, “Number 2”, “M City” and “N City” within the preset time period such as 30 seconds, it is determined that the speech data associated with the push information is acquired. Obviously, the speech data of “M City”, the speech data of “N City”, the speech data of “Number 1”, or the speech data of “Number 2” are all speech data associated with the push information. That is, when the user speaks any one of the answer options, the target file is played.

In this embodiment, when the speech data acquired within the preset time period includes any target character in the target character set corresponding to the candidate reply sentence, the target file is played.

In the embodiment of the disclosure, when the speech data associated with the push information is obtained within the preset time period, the candidate reply sentence corresponding to the preset push information is parsed to determine the target character set. Speech recognition is performed on the acquired speech data, and in response to any target character in the target character set being included in the speech data acquired within the preset time period, it is determined that the speech data associated with the push information is acquired. Therefore, when the user answers any answer in the push information by speech, the target file is played, which improves the interaction effect between the user and the intelligent speech apparatus and improves the user's enthusiasm for using the intelligent speech apparatus.

In practical applications, there are many push information to be pushed by the intelligent speech apparatus. In order to deepen the user awareness of the push information associated with the file to be played, in an embodiment of the disclosure, the preset push information is determined according to a file type of the target file, before the above-mentioned intelligent speech apparatus pushes the preset push information.

For example, when a speech of “playing song C” is inputted by the user, and the type of song C is a folk song, then the preset push information may be associated with folk songs.

In this embodiment, after determining the preset push information according to the file type of the target file, when the file permission does not match the current user permission of the user of the intelligent speech apparatus, the intelligent speech apparatus is controlled to play the preset push information determined according to the file type of the target file.

In the embodiment of the disclosure, before controlling the intelligent speech apparatus to play the preset push information, the preset push information is determined according to the file type of the target file, thereby controlling the intelligent speech apparatus to play the push information associated with the file type of the target file, which deepens the user awareness of the push information associated with the target file and improves push effect.

In order to improve the push effect of the push information, in an embodiment of the disclosure, before controlling the intelligent speech apparatus to play the preset push information, the preset push information is determined according to the file permission of the target file.

In detail, a correspondence between the file permission and the push information is established in advance, for example, the higher the file permission, the greater difficulty of pushing the corresponding push information. The difficulty refers to the difficulty of the problems included in the push information.

For example, when a music requested by the user is a primary member music, the difficulty of pushing the push information is lower. When the music requested by the user is a middle member music, the difficulty of pushing the push information is increased.

In this embodiment, after the preset push information is determined according to the file permission of the target file, when the file permission does not match the current user permission of the user of the intelligent speech apparatus, the intelligent speech apparatus is controlled to play the preset push information according to the permission of the target file.

In the embodiment of the disclosure, before controlling the intelligent speech apparatus to play the preset push information, the preset push information is determined according to the file permission of the target file, the intelligent speech apparatus is controlled to play the push information determined according to the permission of the target file, thereby improving the interactive effect and the push effect of the push information.

In order to improve the push effect of the push information, in an embodiment of the disclosure, before controlling the intelligent speech apparatus to play the preset push information, the preset push information may also be determined according to a time when the play command is received.

In actual applications, the user handles different things when the intelligent speech apparatus at different times, therefore different push information may be pushed. In detail, the time when the play command is acquired is recorded when the play command is received. In response to determine that the file permission of the target file in the play command does not match the current user permission of the user of the intelligent speech apparatus, a time period to which the time when the play command is acquired belongs is determined, for example, morning, forenoon and noon. The preset push information is determined according to the time period to which the time when the play command is acquired belongs, and then the intelligent speech apparatus is controlled to play the preset push information.

For example, when the user uses the intelligent speech apparatus in the morning, the user may be washing, then information related to toiletries is pushed. For another example, when the user uses the intelligent speech apparatus at night, then information about products that help to improve sleep quality is pushed.

In this embodiment, after the preset push information is determined according to the time when the play command is received, the intelligent speech apparatus is controlled to play the preset push information according to the time when the play command is received, when the file permission does not match the current user permission of the user of the intelligent speech apparatus.

In this embodiment, before controlling the intelligent speech apparatus to play the preset push information, the preset push information is determined according to the time when the play command is received, thereby pushing the corresponding information according to the time period of using the intelligent speech apparatus, which improves the push effect of the push information.

Further, in order to deepen the user awareness of the push information, in an embodiment of the disclosure, after the speech data associated with the push information is received within the preset time period, the target reply sentence corresponding to the push information is played.

The target reply sentence corresponding to the push information is understood as the correct answer to the question included in the push information.

In this embodiment, when the file permission of the target file in the play command does not match the current user permission of the user of the intelligent speech apparatus, the intelligent speech apparatus is controlled to play the preset push information. The intelligent speech apparatus is controlled to play the preset push information, and after the speech data associated with the push information is acquired within the preset time period, the target reply sentence corresponding to the push information is played, and then the target file is played.

For example, the push information is “in which city will singer a hold a concert in April this year? Number 1: M city, Number 2: N city”. When the user answers by speech, whether the user's answer is correct is determined. In response to the answer being correct, a correct broadcast is played, for example, “Congratulations on the answer, it is indeed M city”. In response to the answer being wrong, an incorrect broadcast is played, for example, “It is actually M city”.

In the embodiment of the disclosure, after the speech data associated with the push information is acquired within the preset time period, the target reply sentence corresponding to the push information is played, which further deepens the user awareness of the push information and improves the effect of the push information.

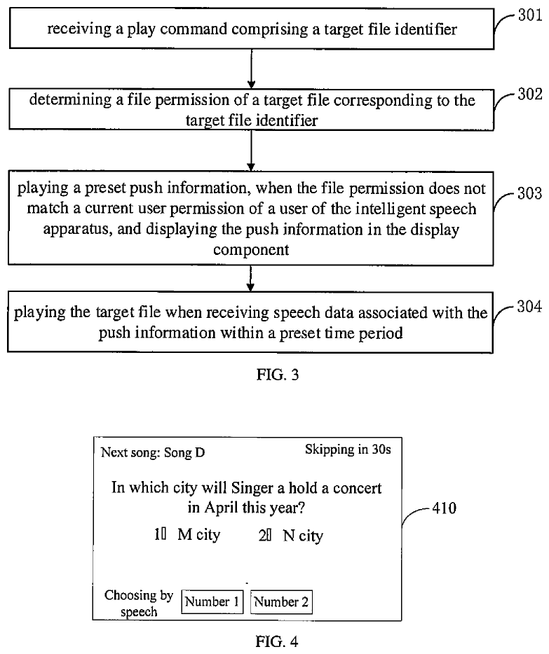

In order to improve interaction effect between the user and the intelligent speech apparatus, in an embodiment of the disclosure, the intelligent speech apparatus may include a display component, such as a display screen. When the push information is played, the push information may also be displayed in the display component. FIG. 3 is a flowchart of yet another method for controlling an intelligent speech apparatus according to an embodiment of the disclosure.

As illustrated in FIG. 3, the method for controlling the intelligent speech apparatus includes the following blocks.

At block 301, a play command including a target file identifier is obtained.

At block 302, a file permission of a target file corresponding to the target file identifier is determined.

In this embodiment, blocks 301 to 302 are similar to the above blocks 101 to 102, which will not be repeated herein.

At block 303, the intelligent speech apparatus is controlled to play a preset push information, and the push information is displayed in a display component when the file permission does not match a current user permission of a user of the intelligent speech apparatus.

In this embodiment, the intelligent speech apparatus has the display component, such as a display screen. When it is determined that the file permission of the target file does not match the current user permission of the user of the intelligent speech apparatus, the intelligent speech apparatus is controlled to play the preset push information, and the push information is displayed in the display component, which is convenient for the user to view the push information.

In addition, the display component may also display a prompt information, such as a name of the target file, an interaction time, and how to answer the question by speech.

FIG. 4 is a schematic diagram of a display component according to an embodiment of the disclosure. As illustrated in FIG. 4, the display component 410 displays the push information “in which city will singer a hold a concert in April this year? Number 1: M city, Number 2: N city”. Meanwhile, an upper left corner of the display component 410 also displays “Next song: Song D”, and a lower left corner of the display component 410 prompts the user to answer the question by inputting “Number 1” or “Number 2” through speech. An upper right corner of the display component 410 displays “Skipping in 30 s” to prompt the user to answer the question within 30 seconds. When the user fails to answer the question within 30 s, the interactive question and answer is skipped.

It should be noted that FIG. 4 is only an example and could not be regarded as a limitation of the disclosure. In detail, contents displayed by the display component and display positions are controlled according to specific requirements.

At block 304, the target file is played when receiving speech data associated with the push information within a preset time period.

In this embodiment, block 304 is similar to block 104 described above, which will not be repeated here.

Further, in order to improve the effect of the push information, the intelligent speech apparatus may display target information corresponding to the push information on the display component while playing the target file. For example, the push information played by a smart speaker is about a certain toothpaste brand, then when the smart speaker plays the target file, advertisement information of the toothpaste brand is displayed on the display screen of the smart speaker, thereby improving the push effect of the push information.

In an embodiment of the disclosure, the intelligent speech apparatus includes the display component, and the push information is displayed in the display component when the file permission does not match the current user permission of the user of the intelligent speech apparatus. As a result, the intelligent speech apparatus displays the push information in the display component while playing the push information, so that the user accurately learns the push information, and prevents the user from missing interaction opportunity due to not hearing or remembering the push information, so that the interaction effect between the user and the intelligent speech apparatus is improved.

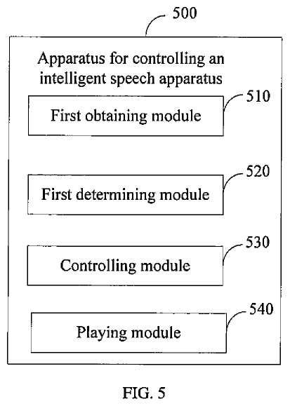

In order to implement the foregoing embodiment, the embodiment of the disclosure also provides an apparatus for controlling an intelligent speech apparatus. FIG. 5 is a schematic diagram of an apparatus for controlling an intelligent speech apparatus according to an embodiment of the disclosure.

As illustrated in FIG. 5, the apparatus for controlling the intelligent speech apparatus 500 further includes: a first obtaining module 510, a first determining module 520, a controlling module 530 and a playing module 540.

The first obtaining module 510 is configured to receive a play command including a target file identifier. The first determining module 520 is configured to determine a file permission of a target file corresponding to the target file identifier. The controlling module 530 is configured to control the intelligent speech apparatus to play a preset push information, when the file permission does not match a current user permission of a user of the intelligent speech apparatus. The playing module 540 is configured to play the target file when receiving speech data associated with the push information within a preset time period.

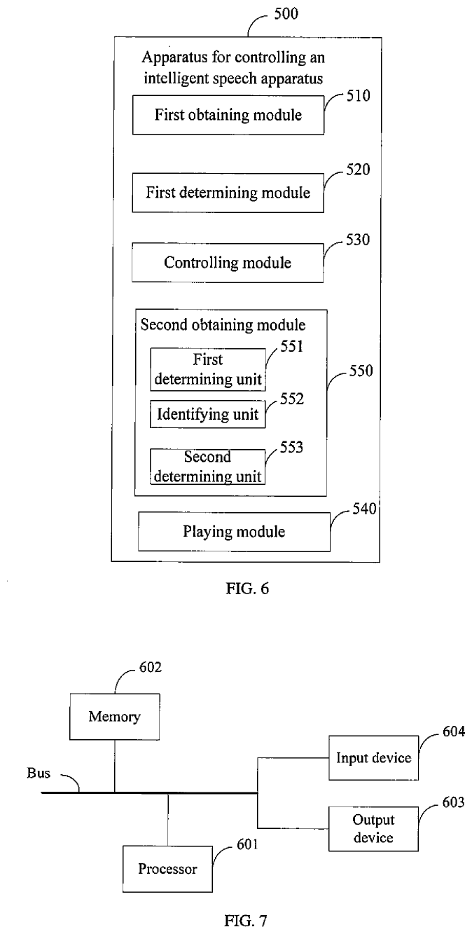

FIG. 6 is a schematic diagram of another apparatus for controlling an intelligent speech apparatus according to an embodiment of the disclosure. In a possible implementation of the embodiment of the disclosure, as illustrated in FIG. 6, the apparatus may further include: a second obtaining module 550, the second obtaining module 550 includes: a first determining unit 551, an identifying module 552 and a second determining unit 553. The first determining unit 551 is configured to determine a target character set by parsing a candidate reply sentence corresponding to the preset push information. The identifying module 552 is configured to perform speech recognition on the speech data. The second determining unit 553 is configured to determine that the speech data associated with the push information is acquired in response to determining that the speech data acquired within the preset time period comprises any target character in the target character set.

In a possible implementation of the embodiment of the disclosure, the apparatus further includes a second determining module configured to determine the preset push information according to a file type of the target file.

In a possible implementation of the embodiment of the disclosure, the apparatus further includes a third determining module configured to determine the preset push information according to the file permission of the target file.

In a possible implementation of the embodiment of the disclosure, the apparatus further includes a fourth determining module configured to determine the preset push information according to a time when the play command is received.

In a possible implementation of the embodiment of the disclosure, the playing module 540 is further configured to play a target reply sentence corresponding to the push information.

In a possible implementation of the embodiment of the disclosure, the intelligent speech apparatus includes a display component, and the apparatus further includes a displaying module, the displaying module is configured to display the push information in the display component when the file permission does not match the current user permission of the user of the intelligent speech apparatus.

It should be noted that the explanation of the foregoing embodiment of the method for controlling the intelligent speech apparatus is also applicable to the apparatus for controlling the intelligent speech apparatus of this embodiment, which will not be repeated herein.

With the apparatus for controlling the intelligent speech apparatus according to the embodiment of the disclosure, the play command including a target file identifier is received. The file permission of the target file corresponding to the target file identifier is determined. The intelligent speech apparatus is controlled to play the preset push information, when the file permission does not match the current user permission of the user of the intelligent speech apparatus. The target file is played when receiving speech data associated with the push information within a preset time period. Therefore, the method provides the push information to the user when using the non-authorized files, which not only enriches speech interaction modes, but also deepens the user awareness of the push information and improves information pushing effect.

According to the embodiments of the present disclosure, the disclosure also provides an electronic device and a readable storage medium.

FIG. 7 is a block diagram of an electronic device used to implement the method for controlling an intelligent speech apparatus according to an embodiment of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 7, the electronic device includes: one or more processors 601, a memory 602, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 601 is taken as an example in FIG. 7.

The memory 602 is a non-transitory computer-readable storage medium according to the disclosure. The memory stores instructions executable by at least one processor, so that the at least one processor executes the method according to the disclosure. The non-transitory computer-readable storage medium of the disclosure stores computer instructions, which are used to cause a computer to execute the method according to the disclosure.

As a non-transitory computer-readable storage medium, the memory 602 is configured to store non-transitory software programs, non-transitory computer executable programs and modules, such as program instructions/modules (For example, the first obtaining module 510, the first determining module 520, the controlling module 530, and the playing module 540 shown in FIG. 5) corresponding to the method in the embodiment of the disclosure. The processor 601 executes various functional applications and data processing of the server by running non-transitory software programs, instructions, and modules stored in the memory 602, that is, implementing the method in the foregoing method embodiments.

The memory 602 may include a storage program area and a storage data area, where the storage program area may store an operating system and application programs required for at least one function. The storage data area may store data created according to the use of the electronic device for implementing the method. In addition, the memory 602 may include a high-speed random access memory, and a non-transitory memory, such as at least one magnetic disk storage device, a flash memory device, or other non-transitory solid-state storage device. In some embodiments, the memory 602 may optionally include a memory remotely disposed with respect to the processor 601, and these remote memories may be connected to the electronic device for implementing the method through a network. Examples of the above network include, but are not limited to, the Internet, an intranet, a local area network, a mobile communication network, and combinations thereof.

The electronic device for implementing the method may further include: an input device 603 and an output device 604. The processor 601, the memory 602, the input device 603, and the output device 604 may be connected through a bus or in other manners. In FIG. 7, the connection through the bus is taken as an example.

The input device 603 may receive inputted numeric or character information, and generate key signal inputs related to user settings and function control of an electronic device for implementing the method, such as a touch screen, a keypad, a mouse, a trackpad, a touchpad, an indication rod, one or more mouse buttons, trackballs, joysticks and other input devices. The output device 604 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, sound input, or tactile input).

The systems and technologies described herein can be implemented in a computing system that includes background components (for example, a data server), or a computing system that includes middleware components (for example, an application server), or a computing system that includes front-end components (For example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other.

According to the technical solution of the embodiment of the disclosure, the method provides the push information to the user when using the non-authorized files, which not only enriches speech interaction modes, but also deepens the user's awareness of the push information and improves information pushing effect.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

Although embodiments of present disclosure have been shown and described above, it should be understood that above embodiments are just explanatory, and cannot be construed to limit the present disclosure, for those skilled in the art, changes, alternatives, and modifications can be made to the embodiments without departing from spirit, principles and scope of the present disclosure.

What is claimed is:

1. A method for controlling an intelligent speech apparatus, comprising:
receiving a play command comprising a target file identifier;
determining a file permission of a target file corresponding to the target file identifier;
playing a preset push information, when the file permission does not match a current user permission of a user of the intelligent speech apparatus; and
playing the target file when receiving speech data associated with the push information within a preset time period.

2. The method according to claim 1, wherein receiving the speech data associated with the push information within the preset time period, comprises:
determining a target character set by parsing a candidate reply sentence corresponding to the preset push information;
performing speech recognition on the speech data; and
determining that the speech data associated with the push information is acquired in response to determining that the speech data acquired within the preset time period comprises any target character in the target character set.

3. The method according to claim 1, before controlling the intelligent speech apparatus to play the preset push information, further comprising:
determining the preset push information according to a file type of the target file.

4. The method according to claim 1, before controlling the intelligent speech apparatus to play the preset push information, further comprising:
determining the preset push information according to the file permission of the target file.

5. The method according to claim 1, before controlling the intelligent speech apparatus to play the preset push information, further comprising:
determining the preset push information according to a time when the play command is received.

6. The method according to claim 1, after receiving the speech data associated with the push information within the preset time period, further comprising:
playing a target reply sentence corresponding to the push information.

7. The method according to claim 1, wherein
the intelligent speech apparatus comprises a display component, and
the method further comprises:
displaying the push information in the display component when the file permission does not match the current user permission of the user of the intelligent speech apparatus.

8. An electronic device, comprising:
at least one processor; and
a memory communicatively connected to the at least one processor; wherein,
the memory stores instructions executable by the at least one processor, and the processor is configured to:
receive a play command comprising a target file identifier;
determine a file permission of a target file corresponding to the target file identifier;
perform a first instruction to play a preset push information, when the file permission does not match a current user permission of a user of the intelligent speech apparatus; and
perform a second instruction to play the target file when receiving speech data associated with the push information within a preset time period.

9. The electronic device according to claim 8, wherein the processor is further configured to:
determine a target character set by parsing a candidate reply sentence corresponding to the preset push information;
perform speech recognition on the speech data; and
determine that the speech data associated with the push information is acquired in response to determining that the speech data acquired within the preset time period comprises any target character in the target character set.

10. The electronic device according to claim 8, wherein the processor is further configured to:
determine the preset push information according to a file type of the target file.

11. The electronic device according to claim 8, wherein the processor is further configured to:
determine the preset push information according to the file permission of the target file.

12. The electronic device according to claim 8, wherein the processor is further configured to:
determine the preset push information according to a time when the play command is received.

13. The electronic device according to claim 8, wherein the processor is further configured to:
perform a third instruction to play a target reply sentence corresponding to the push information.

14. The electronic device according to claim 8, wherein
the electronic device comprises a display component, and
the processor is further configured to:
control the displaying module to display the push information in the display component when the file permission does not match the current user permission of the user of the intelligent speech apparatus.

15. A non-transitory computer-readable storage medium storing computer instructions, wherein the computer instructions are used to cause the computer to implement a method for controlling the intelligent speech apparatus, and the method comprises:
receiving a play command comprising a target file identifier;
determining a file permission of a target file corresponding to the target file identifier;
playing a preset push information, when the file permission does not match a current user permission of a user of the intelligent speech apparatus; and
playing the target file when receiving speech data associated with the push information within a preset time period.

16. The storage medium according to claim 15, wherein receiving the speech data associated with the push information within the preset time period, comprises:
determining a target character set by parsing a candidate reply sentence corresponding to the preset push information;
performing speech recognition on the speech data; and
determining that the speech data associated with the push information is acquired in response to determining that the speech data acquired within the preset time period comprises any target character in the target character set.

17. The storage medium according to claim 15, before controlling the intelligent speech apparatus to play the preset push information, the method further comprising at least on of:
determining the preset push information according to a file type of the target file; or
determining the preset push information according to the file permission of the target file; or
determining the preset push information according to a time when the play command is received.

18. The storage medium according to claim 15, after receiving the speech data associated with the push information within the preset time period, the method further comprising:
playing a target reply sentence corresponding to the push information.

19. The storage medium according to claim 15, the method further comprising:
displaying the push information in a display component when the file permission does not match the current user permission of the user of the intelligent speech apparatus.
